(19) United States
(12) Patent Application Publication
(10) Pub. No.: US 2008/0169335 A1
(43) Pub. Date: Jul. 17, 2008

(54) Welding apparatus and method

(75) Inventor: Terrance J. Aarnio, Milwaukie, OR (US)

Correspondence Address: Ingrid McTaggart, 3021 S.E. 56th Ave., Portland, OR, 97206, US

(73) Assignee: Oregon Iron Works, Inc.

(21) Appl. No.: 11/654,948

(22) Filed: Jan. 17, 2007

(51) Int. Cl. B23K 31/02; B23K 37/00

(52) U.S. Cl. 228/176; 228/57; 228/18; 228/101; 228/178

(57) ABSTRACT

One embodiment of a welding apparatus includes a stationary welding device that defines a stationary weld zone, and a support that moves a weld member through the stationary weld zone.

### BACKGROUND

A typical welding process may include supplying an amperage at a weld site to melt a welding wire in a desired location. For large welding operations, it may be desirable to provide a time and cost efficient apparatus and method for conducting the welding process.

### BRIEF DESCRIPTION OF THE DRAWINGS

FIG. 1 is a top view of a welding apparatus.

FIG. 2 is a side view of the welding apparatus of FIG. 1.

FIG. 3 is a front view of an alignment structure of FIG. 1.

FIG. 4A is a front view of a holding structure of FIG. 1.

FIG. 4B is another embodiment of a holding structure.

FIG. 5A is a top detailed view of a weld zone of FIG. 1.

FIG. 5B is a detailed view of a weld torch of FIG. 1.

FIG. 6 is a front view of a cleaning structure of FIG. 1.

FIG. 7 is a front view of a vacuum structure of FIG. 1.

FIG. 8 is a front view of a straightening structure of FIG. 1.

FIG. 9 is a front view of a grounding structure of FIG. 1.

### DETAILED DESCRIPTION OF THE DRAWINGS

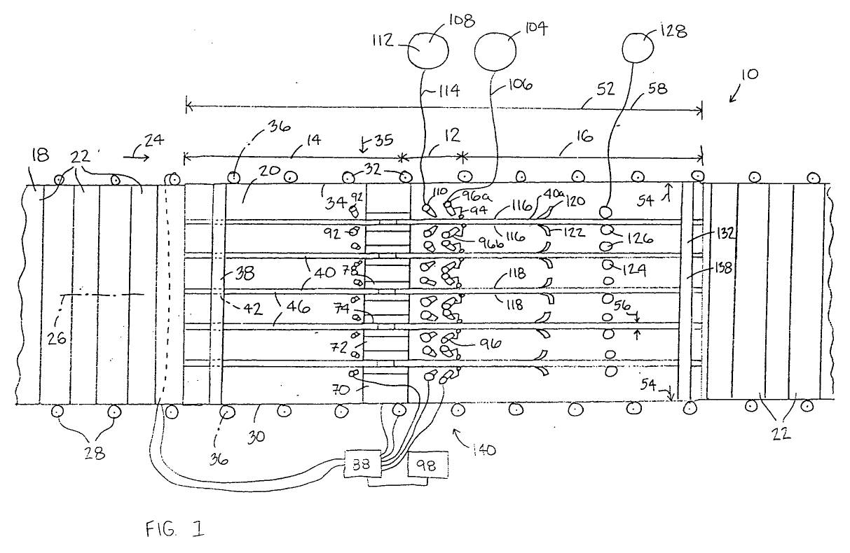

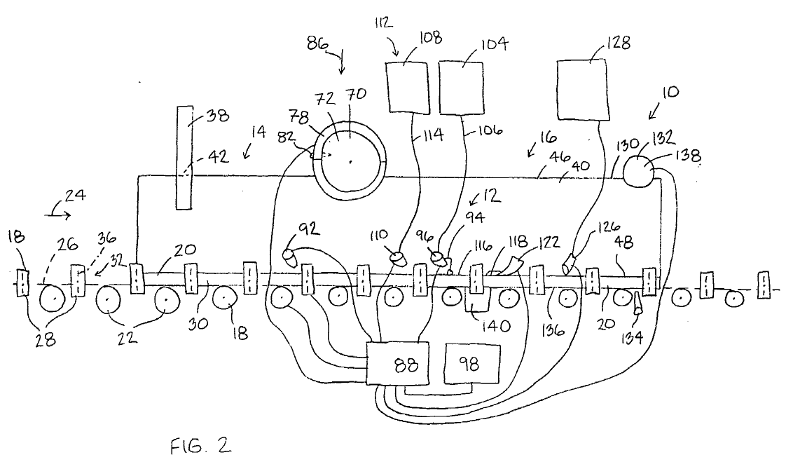

FIGS. 1 and 2 are a top view and a side view, respectively, of a welding apparatus 10 including a stationary weld zone 12, an upstream region 14 positioned upstream from weld zone 12, and a downstream region 16 positioned downstream from weld zone 12. Apparatus 10 includes a movement structure, such as a conveyor system 18 that moves a weld member, such as a large sheet of steel 20, into and through stationary weld zone 12.

Conveyor system 18 may include multiple rollers 22 that move steel sheet 20 in a forward direction of movement 24 along a movement axis 26 toward stationary weld zone 12. In the embodiment shown, steel sheet 20 may be positioned directly on multiple rollers 22 or may be positioned on an endless conveyor belt (not shown) that is secured on and moved by multiple rollers 22.

Conveyor system 18 may further include datum structure, such as datum rollers 28, positioned in a first edge region 30 (see FIG. 2) of conveyor system 18. Conveyor system 18 may also include biasing structure, such as biasing rollers 32 (see FIG. 2) in a second edge region 34 of conveyor system 18, that may bias steel sheet 20 in a direction 35 against datum rollers 28. Datum rollers 28 may define a datum position for steel sheet 20 such that steel sheet 20 is positioned in a known position as the sheet 20 is fed into stationary weld zone 12 along forward direction 24. In the embodiment shown, datum rollers 28 and biasing rollers 32 may each define a vertical rotational axis 36 (see FIG. 2) positioned perpendicular to movement axis 26 such that the rollers do not frictionally hinder movement of steel sheet 20 along forward direction 24 on conveyor system 18.

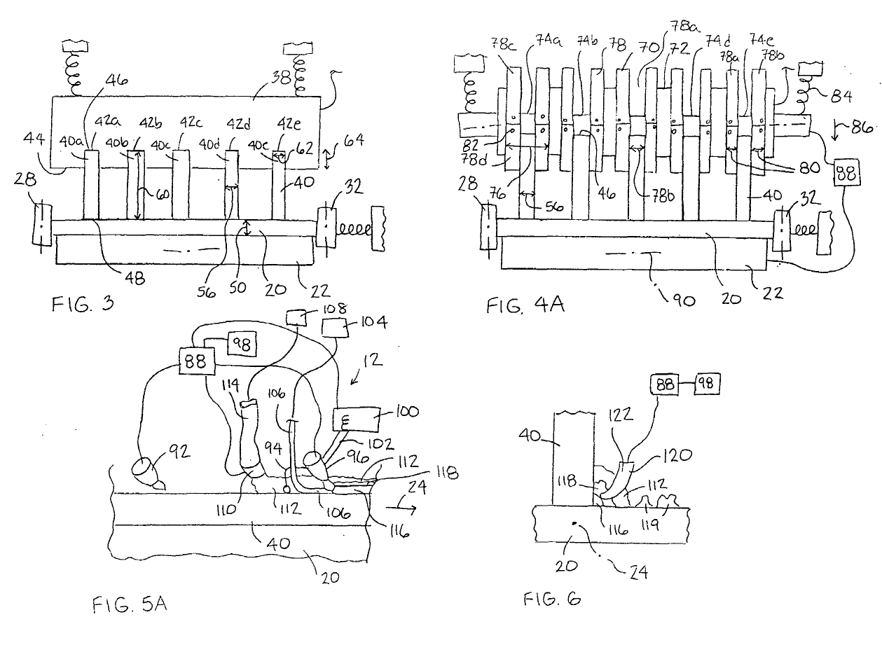

Welding apparatus 10 may include, in upstream region 14, an aligning structure, such as an alignment plate 38, that aligns support members, or stiffeners 40, on steel sheet 20. The alignment plate 38 may be positioned with respect to datum rollers 28 such that stiffeners 40 are positioned on steel sheet 20 by alignment plate 38 in a desired location. Alignment plate 38 may include any type of alignment structure and, in one embodiment, may include a groove 42 (see FIG. 3) to receive therein an edge of stiffener 40 and thereby align the stiffener on steel sheet 20.

Referring to FIG. 3, in one embodiment, five stiffeners 40a-40e may be aligned on steel sheet 20 for welding thereto. Of course, in other embodiments, other numbers of stiffeners may be aligned on one or more metal sheets for welding thereto. Accordingly, alignment plate 38 may include five grooves 42a-42e, that are positioned on a lower edge 44 of alignment plate 38, each in a predetermined position to align a top edge 46 of each of stiffeners 40a-40e, thereby aligning a lower edge 48 of each stiffener 40 on steel sheet 20. Alignment plate 38 may be held stationary within welding apparatus 10 such that as steel plate 20 and stiffeners 40 are moved by conveyor system 18 in forward direction 24 (see FIG. 1), the stiffeners 40a-40e move through stationary grooves 42a-42e.

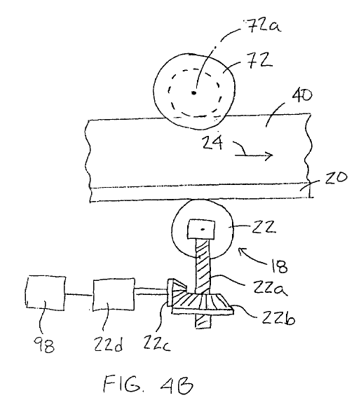

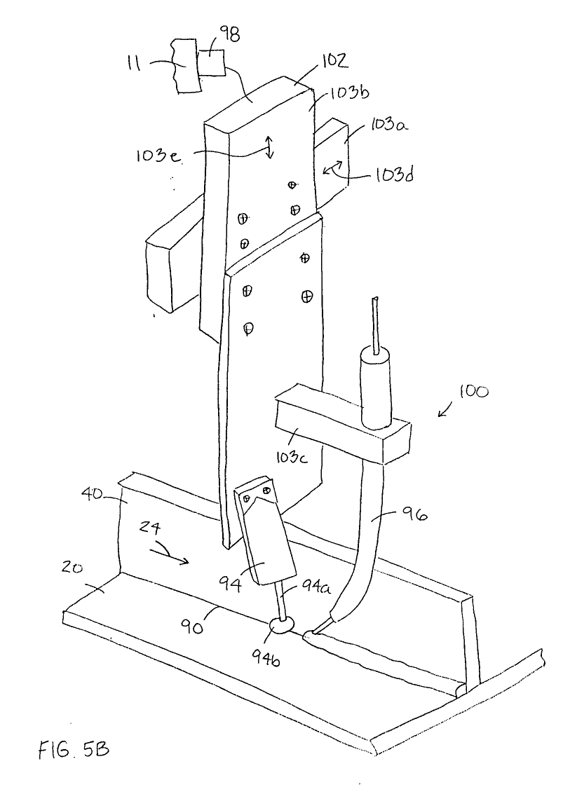

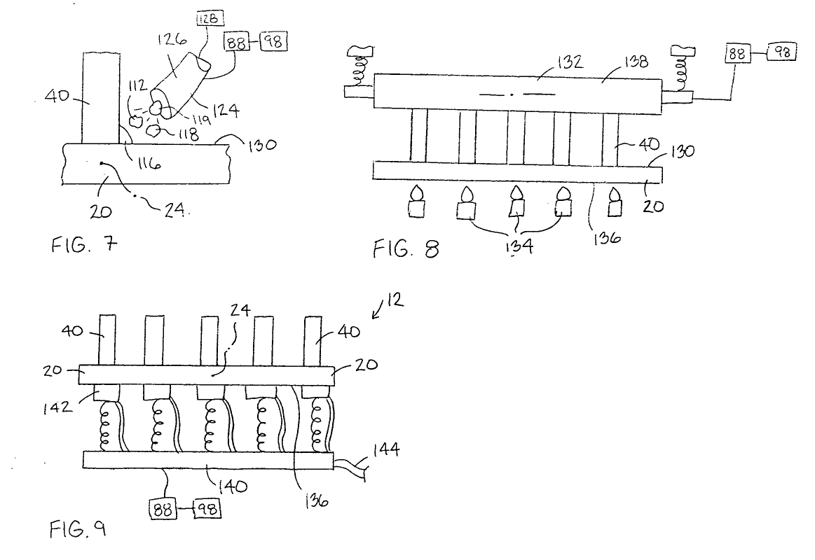

In one embodiment, steel sheet 20 may have a thickness 50 of one half inch, a length 52 (see FIG. 1) of fifty feet, and a width 54 (see FIG. 1) of ten feet. Stiffeners 40 may each have a thickness 56 of one inch, a length 58 (see FIG. 1) of fifty feet, and a height 60 of ten inches. In such an embodiment, alignment plate 38 may include grooves 42 having a width 62 of just over one inch and a depth 64 of approximately three inches, so as to position the stiffeners 40 on steel sheet 20 as the sheet is fed by conveyor system 18 to a holding structure 70 (see FIG. 4) in stationary weld zone 12.

Referring to FIG. 4A, in the embodiment shown, holding structure 70 is a pinch roller 72 including multiple grooves 74a-74e, wherein each groove 74 is sized to receive and hold a stiffener 40 in place and in contact with steel sheet 20. Each groove 74 may be manufactured having a width 76 larger than a thickness 56 of stiffeners 40 and may include a fitting structure, such as a collar 78, that adjusts a size of groove 74 such that a top edge 46 of a stiffener 40 is firmly secured therein. For example, groove 74 may have a width 76 of five inches. A stiffener 40 held within collar 78 may have a thickness 56 of one inch. Accordingly, in one embodiment, a single collar 78 may be secured within groove 74 and may have a thickness 80 of four inches to define a collar groove 78a having a width 78b of approximately one inch, such that stiffener 40 is firmly held within groove 74 of roller 72. In the embodiment shown, two collars 78a-78b may be utilized, one on either side of stiffener 40, wherein each collar may have a thickness 80 of two inches such that stiffener 40 is firmly held within collar groove 78a of collar 78, which may be secured within groove 74 of roller 72.

The use of collars 78 on roller 72 may allow a single roller 72 to be permanently secured within welding apparatus 10 (see FIG. 1), wherein different sized collars 78 may be secured on roller 72 such that roller 72 may firmly hold different sized stiffeners 40 on steel sheet 20 without changing out roller 72. In the embodiment shown, an individual collar 78 may include two half sections 78c-78d which are secured on roller 72 with cap screws 82.

Roller 72 may be biased by springs 84 such that the top edge 46 of each of stiffeners 40 is firmly received within groove 74 of roller 72, such that roller 72 forces stiffeners 40 downwardly in downward direction 86 onto steel plate 20 on rollers 22. In another embodiment, jack screws may be used to bias roller 72 into position instead of the use of springs. In the embodiment shown, springs 84 may have a spring force great enough to firmly press stiffeners 40 into contact with steel sheet 20 in weld zone 12 (see FIG. 1) such that the stiffener 40 may be welded to steel sheet 20. In a case where a stiffener 40 may have an upward bow and therefore may be out of contact with steel sheet 20 in a region immediately proceeding stationary weld zone 12, spring 84 may provide a large downward force to straighten stiffener 40 so that it contacts steel sheet 20 along a length of stiffener 40, and in particular, within weld zone 12 (see FIG. 1).

Roller 72 may be driven by a motor 88 to turn at the same rotational speed as multiple rollers 22 of conveyor system 18, which may also be driven by motor 88, such that holding structure roller 72 may facilitate forward movement of steel sheet 20 toward stationary weld zone 12. Roller 72, which may be positioned above stiffeners 40, and multiple rollers 22, which may be positioned below steel sheet 20, may frictionally contact the stiffeners 40 and the steel sheet 20, respectively, and thereby facilitate forward movement of steel sheet 20. In another embodiment roller 72 may not be driven but may rotate about its rotational axis 90 by frictional contact with top edge 46 of stiffeners 40, which frictionally contact steel sheet 20, as rollers 22 frictionally contact and move steel sheet 20 toward stationary weld zone 12 (see FIG. 1).

FIG. 4B shows another embodiment of roller 72. In this embodiment, roller 72 is fixed in position about its rotational axis 72a. A roller 22 positioned within conveyor system 18 and underneath steel sheet 20 may be moved by a gear system so as to pinch steel sheet 20 and stiffener 40 between rollers 22 and 72. Roller 22 may include a screw jack 22a attached to a first gear 22b and a second gear 22c, wherein second gear 22c is operated by a motor 22d. Motor 22d may turn second gear 22c so as to turn first gear 22b to pinch steel plate 20 and stiffener 40 between rollers 22 and 72.

Referring to FIG. 5A, in the example embodiment shown, weld zone 12 may include ten stationary weld torches 96a-j (only one shown for ease of illustration), i.e., one weld torch 96 for each side of a stiffener 40. Of course, in other embodiments, other number of weld torches, also referred to as weld heads, may be utilized. Accordingly; weld torches 96a and 96b (see FIG. 1) are positioned to weld each side of a first stiffener 40a (see FIG. 1) to steel sheet 20; weld torches 96c and 96d are positioned to weld each side of a second stiffener 40b to steel sheet 20; weld torches 96e and 96f are positioned to weld each side of a third stiffener 40c to steel sheet 20; weld torches 96g and 96h are positioned to weld each side of a fourth stiffener 40d to steel sheet 20; and weld torches 96i and 96j are positioned to weld each side of a fifth stiffener 40e to steel sheet 20.

Each of weld torches 96 may include it's own pre-heat weld torch 92, its own seam tracker device 94, its own control system 98 and its own positioning system 100 that biases weld torch 96 into position at the contact point of stiffener 40 (shown in top view) and steel sheet 20. The weld torches 96 may be controlled by control system 98 to be retracted after finishing a weld line on a steel sheet 20. However, during welding of a stiffener 40 to steel sheet 20, the individual weld torches 96 will remain stationary. In other words, during operation, weld torches 96 are stationary in stationary weld zone 12, and steel sheet 20 is moved past the weld torches and through stationary weld zone 12 in forward direction 24.

In one example embodiment, sheet 20 is moved in forward direction 24 at a rate of twenty to thirty inches per minute through stationary welding apparatus 10 and stationary weld torch 96 simultaneously creates a 5/16^{th} inch weld 116 on each side of the five stiffeners 40. In other words, welding apparatus 10 simultaneously welds ten weld lines on moving steel sheet 20. Each stationary weld torch 96 generates a welding amperage of 600 to 700 amps at each of the ten welds. In other embodiments, other weld rates and amperages or other process variables may be utilized to produce welds with a different thickness than the example embodiment described.

Control system 98 may include an operator controlled computer system that controls the arc of its corresponding weld torch 96, the on and off condition of the weld torch, and may give the operator a signal that indicates whether or not the weld torch 96 is correctly positioned by seam tracker 94 to weld stiffener 40 to steel sheet 20. Control system 98 may also be connected to and control other components of welding apparatus 10, such as the rotational speed of rollers 22 and 72, and the force of roller 72 that is exerted on stiffeners 40.

Referring to FIG. 5B, positioning system 100 may include a spring loaded positioning arm 102 that positions each weld torch 96 adjacent the line of contact 90 between stiffener 40 and steel sheet 20. Arm 102 may be controlled by control system 98 such that after welding along the length of stiffener 40 and steel sheet 20, arm 102 maybe raised as a new sheet 20 is fed into stationary weld zone 12. Positioning arm 102 may include an “x” direction cross slide 103a and a “y” direction cross slide 103b mechanically secured to “x” direction cross slide 103a. A bracket 103c may be mechanically secured to “y” direction cross slide 103b, and may secure therein a weld head or weld torch 96. The seam tracker 94 may also be secured to “y” direction cross slide 103b. The “x” and “y” cross slides 103a and 103b may be moved in the “x” and “y” directions, 103d and 103e respectively, by a gear mechanism (not shown) controlled by control system 98 (see FIG. 5A).

In operation positioning arm 102 may be guided by seam tracker 94. Seam tracker 94 may include a guide rod 94a and guide ball 94b positioned on the end of guide rod 94a. Guide ball 94b may touch and mechanically follow the line of contact 90 just upstream of weld torch 96. The motion of seam tracker 94 relative to the machine frame 11 may create an electronic signal which may be fed to controller 98. Controller 98 may then send signal commands to the gear system that moves x and y cross slides 103a and 103b. The x and y cross slides define a movable interface between the machine frame 11 and the torch or weld held 96. As seam tracker 94 moves, the x and y cross slides 103a and 103b mimic the same motion thus keeping torch head 96 in a correct position relative to line of contract 90 of the seam being welded. Weld head 96 may be rigidly mounted to the x and y cross slides 103a and 103b whereas seam tracker guide rod 94a may be spring loaded and thereby forced to stay on seam or line of contact 90.

In the example embodiment shown there may be ten positioning arms 102a-102j (only one shown for ease of illustration), each arm associated with its corresponding weld torch 96a-96j (see FIG. 1).

Referring again to FIG. 5A, each of weld torches 96 may be associated with a rotating wire supply tub 104 wherein a wire 106 from each tub is connected to its own corresponding weld torch to provide the raw material for the weld between stiffener 40 and steel sheet 20. In the example embodiment shown there may be ten rotating wire supply tubs 104a-104j, each tub associated with its corresponding weld torch 96a-96j (see FIG. 1). Due to their large size, tubs 104 may be positioned adjacent to stationary weld zone 12, wherein a wire from each tub is fed into weld zone 12.

Each of weld torches 96 may also be associated with a flux tub 108 and a flux outlet port 110 wherein a thick layer of flux material 112 is deposited over wire 106 such that weld torch 96 welds wire 106 in an oxygen free environment. In the example embodiment shown there are ten flux tubs 108a-108j, each tub associated with its corresponding weld torch 96a-96j. Due to their large size, tubs 108 may be positioned adjacent to stationary weld zone 12, wherein flux from each tub is fed into weld zone 12 via a flux conduit 114.

As steel sheet 20 is moved out of stationary weld zone 12, in the example embodiment shown, a weld line 116 of molten weld wire 106, fused with a melted portion of each of the stiffener 40 and the steel sheet 20, is positioned at the intersection of each side of stiffeners 40 on steel sheet 20, as is covered by a thick layer of flux material 112. Accordingly, in stationary weld zone 12, ten weld lines 116 are simultaneously being created, with each weld line being covered in flux material 112. Some of flux material 112 is melted during the welding process and leaves weld zone 12 in the form of slag 118, which generally is cleaned by a slag cleaning structure 120 (see FIG. 6).

Referring to FIG. 6, slag cleaning structure 120 may include a scraper arm 122 positioned to scrape slag 118 from weld line 116 which may generate loose slag debris 119. Slag cleaning structure 120 may be stationarily positioned such that weld line 116 on steel sheet 20 is moved by scraper arm 122 as sheet 20 moves. In the example embodiment shown there may be ten scraper arms 122a-122j, each scraper arm 122 associated with its corresponding weld torch 96a-96j and corresponding weld line 116a-116j. The loosened slag 119 may be left on steel sheet 20 as the sheet 20 is moved past scraper arm 122 for pick up by a vacuum structure 124 (see FIG. 7) downstream of scraper arm 122. Control system 98 may control scraper arm 122 such that the arms may be raised upwardly from steel sheet 20 and conveyor system 18 (see FIG. 1) after a sheet 20 is completed, thereby allowing positioning of the next steel sheet 20 to be fed through stationary weld zone 12. The scraper arms may be controlled by control system 98 to be retracted after finishing a scrape of a steel sheet 20. However, during scraping of a weld line 116 on steel sheet 20, the individual scraper arms 122 will remain stationary. In other words, during operation, scraper arms 122 are stationary in downstream region 16, and steel sheet 20 is moved past the stationary scraper arms 122.

Referring to FIG. 7, a vacuum structure 124 may be controlled by motor 88 and control system 98 and may include a vacuum hose 126 that may vacuum up all loose debris from weld line 116, including unmelted flux 112 and loose slag 119 that is scraped from weld line 116 by scraper arm 122 (see FIG. 6). Vacuum structure 124 may be stationarily positioned such that steel sheet 20 is moved past vacuum structure 124 in forward direction 24. Accordingly, the portion of steel sheet 20 downstream of vacuum structure 124 may include a clean weld site wherein all loose debris is removed, exposing clean weld line 116. In the example embodiment shown there may be ten vacuum hoses 126a-126j, each hose 126 associated with its corresponding weld torch 96a-96j and corresponding weld line 116a-116j. Each vacuum hose 126 may be connected to a flux and/or slag recovery system 128 wherein the flux and/or slag is recycled back to the welding system 10 (see FIG. 1) or disposed of. The vacuum hoses 126 may be controlled by control system 98 to be retracted after finishing a vacuum of a steel sheet 20. However, during vacuuming of a weld line 116 on steel sheet 20, the individual vacuum hoses 126 will remain stationary. In other words, during operation, vacuum hoses 126 are stationary in downstream region 16, and steel sheet 20 is moved past the vacuum hoses in forward direction 24. In another embodiment, each of individual vacuum hoses 126 may be replaced by a single, large vacuum hood (not shown) that may create a suction great enough to vacuum all debris from sheet 20, at each of stiffeners 40a-40e.

After moving past stationary weld zone 12, steel sheet 20 and the attached, welded stiffeners 40 may have experienced large amounts of heat from each of individual weld torches 96 (see FIG. 1) on an upward side 130 of sheet 20. The large amount of heat directed on a single side 130 of sheet 20 may have caused warping, bowing or otherwise may have deformed the generally flat shape of steel sheet 20 and/or stiffeners 40. Accordingly, welding system 10 may include a straightening structure 132 (see FIG. 8) positioned along conveyor system 18.

Referring to FIG. 8, a straightening structure 132 may include structure for straightening welded sheet 20, such as an array of torches 134 that may heat an underside 136 of sheet 20 so as to counteract the effects to heating upward side 130 of sheet 20 during the welding process. Array of torches 134 may be stationarily positioned below steel sheet 20 such that sheet 20 is moved past the torches during operation. Straightening structure 132 may further include a straightening roller 138 that may bias stiffeners 40 and steel sheet 20 into a generally flat orientation on conveyor system 18 (see FIG. 1). In one example embodiment, straightening roller 138 may be manufactured in a size and shape similar to roller 72 of holding structure 70 and may be stationarily positioned above sheet 20 and stiffeners 40 so as to force the sheet and the stiffeners downwardly onto conveyor system rollers 22 to flatten the newly welded steel sheet 20. In another embodiment, array of torches 134 may be positioned directly underneath weld torches 96 in weld zone 12 (see FIG. 1) so that steel sheet 20 is heated on its upward side 130 and on its underside 136 at the same time to reduce warping or misshaping of sheet 20 during the welding process.

Referring to FIG. 9, a grounding structure 140 of stationary weld zone 12 may include a grounding shoe 142 that is biased upwardly against underside 136 of steel sheet 20 so as to provide an electrical ground during the arc welding process of weld torch 96 (see FIG. 1). Grounding shoe 142 may be manufactured of a metal having a high conductivity, such as bronze, brass, or an aluminum bronze alloy, for example, and may be connected to an electrical ground 144. Stationary grounding shoe 142 may be biased upwardly against underside 136 of steel sheet 20 and may frictionally contact underside 136 of steel sheet 20 as sheet 20 is moved in forward direction 24 by conveyor system 18 (see FIG. 1). The biased, frictional contact of stationary grounding shoe 142 may ensure that moving steel sheet 20 is grounded throughout the process of welding a support member, such as a stiffener 40, to a weld member, such as steel sheet 20. In an application wherein five stiffeners 40 are simultaneously welded to steel sheet 20, five grounding shoes 142a-142e, may be positioned on underside 136 of sheet 20 such that a grounding shoe 142 is associated with each stiffener 40.

In other embodiments, for example, other sizes and numbers of weld members and weld supports, such as stiffeners, may be utilized. The weld member may also be positioned in a different orientation than shown. The weld member may also be moved rearwardly, for example, if it is desired to reweld a section along the length of the weld member.

Other variations and modifications of the concepts described herein may be utilized and fall within the scope of the claims below.

We claim:

1. A welding apparatus, comprising:
a stationary welding device that defines a stationary weld zone; and
a support that moves a weld member through said stationary weld zone.

2. The apparatus of claim 1 wherein said welding device includes a plurality of stationary welding torches that each define a stationary weld zone, wherein said support moves a weld member simultaneously through each of said stationary weld zones.

3. The apparatus of claim 1 further comprising a holding structure that holds a stiffener member on said weld member in said weld zone.

4. The apparatus of claim 2 further comprising a holding structure that simultaneously holds a plurality of stiffener members on said weld member in said weld zone.

5. The apparatus of claim 4 wherein said support defines an axis of weld member movement, said holding structure comprises a roller that defines a rotational axis positioned perpendicular to said axis of weld member movement, and includes a plurality of radial grooves each sized to receive therein an edge of a stiffener member.

6. The apparatus of claim 3 wherein said support defines an axis of weld member movement, said holding structure comprises a roller that defines a stationary rotational axis positioned perpendicular to said axis of weld member movement, and includes a radial groove sized to receive therein an edge of a stiffener member, said holding structure further comprising a collar removably secured on said radial groove, said collar sized to mechanically position the stiffener member within said radial groove during movement of said weld member along said axis of weld member movement.

7. The apparatus of claim 1 wherein said support includes a datum member that defines a datum position of said support, said support further including a biased member that biases a weld member into a datum position against said datum member during movement of a weld member through said stationary weld zone.

8. The apparatus of claim 7 wherein said datum member comprises a plurality of datum rollers aligned in a first edge region of said movable support and said biased member comprises a plurality of spring loaded push rollers aligned in a second edge region of said movable support, opposite said support from said first edge region.

9. The apparatus of claim 3 wherein said holding structure biases a stiffener member into contact with said weld member in said weld zone.

10. The apparatus of claim 1 further comprising a stationary alignment structure positioned upstream of said weld zone, said alignment structure aligning a stiffener member on said weld member upstream of said weld zone.

11. The apparatus of claim 10 wherein said alignment structure comprises a plate including a groove sized to mechanically receive a first edge region of a stiffener member so as to position a second edge region of the stiffener member on a weld member.

12. The apparatus of claim 1 further comprising cleaning structure stationarily positioned in said stationary weld zone and positioned for releasing slag from a weld line on said weld member, said apparatus further comprising a vacuum inlet port that defines a stationary vacuum zone downstream of said weld zone and positioned for vacuuming said slag from said weld member.

13. The apparatus of claim 1 further comprising a stationary grounding device structured to continuously contact a weld member as the weld member is moved through said weld zone.

14. The apparatus of claim 1 further comprising a straightening device structured to bias a weld member into a substantially flat orientation as the weld member is moved through said weld zone.

15. A method of welding, comprising:
stationarily positioning a welding device that defines a stationary weld zone; and
simultaneously moving first and second weld members through said stationary weld zone and welding said first and second weld members together in said stationary weld zone.

16. The method of claim 15 further comprising simultaneously moving a third weld member through said stationary weld zone with said first and second weld members, and simultaneously welding said second and third weld members to said first member in said stationary weld zone.

17. The method of claim 15 further comprising utilizing aligning structure to align said second weld member on said first weld member prior to moving said first and second weld members through said stationary weld zone.

18. The method of claim 15 further comprising utilizing biasing structure to bias said second weld member on said first weld member during welding of said first and second weld members together.

19. The method of claim 15 further comprising simultaneously moving said first and second weld members through a stationary cleaning zone, positioned downstream of said stationary weld zone, to remove slag from a weld line between said first and second weld members.

20. The method of claim 15 further comprising utilizing flattening structure to position said first and second weld members in a substantially unbowed orientation as the first and second weld members are moved through said weld zone.

21. The method of claim 15 wherein said welding device comprises a plurality of welding torches positioned within said stationary weld zone, said plurality of welding torches simultaneously welding multiple weld lines on said first and second weld members.

22. A welding apparatus, comprising:
a movable support that moves a weld member through a stationary weld zone; and
an alignment structure that aligns multiple strengthening members on said weld member and holds said multiple strengthening members in an aligned position on said weld member in said stationary weld zone.

23. The apparatus of claim 22 further comprising a plurality of stationary welding devices positioned in said stationary weld zone.
